(19) United States
(12) Patent Application Publication
(10) Pub. No.: US 2013/0080195 A1
(43) Pub. Date: Mar. 28, 2013

(54) Inventory System and Method Therefor

(71) Applicants: Umit Murad Cholak, Atlanta, GA (US); Metin Gursel Ozisik, Atlanta, GA (US); Timothy Ruberg, Peachtree City, GA (US)

(72) Inventors: Umit Murad Cholak, Atlanta, GA (US); Metin Gursel Ozisik, Atlanta, GA (US); Timothy Ruberg, Peachtree City, GA (US)

(73) Assignee: SITA INFORMATION NETWORKING COMPUTING UK LIMITED, Middlesex (GB)

(21) Appl. No.: 13/436,211

(22) Filed: Mar. 30, 2012

Related U.S. Application Data
(60) Provisional application No. 61/469,547, filed on Mar. 30, 2011.

(51) Int. Cl. G06Q 10/02

(52) U.S. Cl. CPC G06Q 10/02
USPC 705/5

(57) ABSTRACT

An inventory control method and system is disclosed. The system comprises: a processor, a receiver for receiving an availability request for a leg of a journey between an origin and destination, wherein the availability request comprises one or more attributes defining the leg; and a comparator for comparing the attribute or attributes of the received availability request with data defining a plurality of products. Each product defined by one or more attributes comprising a further attribute which allows a local or non-stop passenger to be distinguished from a connecting passenger. The processor is configured to determine the availability of one of the products in dependence upon the result of the comparison.

### CROSS-REFERENCE TO RELATED APPLICATION

The present application claims priority from provisional application No. 61/469,547 entitled “Improved Inventory System and Method Therefor”, filed 30 Mar. 2011, the contents of which are expressly incorporated by reference herein.

### FIELD OF THE INVENTION

This invention relates to an inventory control system. Further, this invention also relates to an inventory control system for use by a merchant, and in particular to an inventory control system for use by an airline.

### BACKGROUND OF THE INVENTION

In order to manage availability of seats on a scheduled flight between two airports, airlines use an inventory control system. In such a system, the inventory of seats on a flight is divided by the passenger demand characteristics into different market segments for Revenue Management (RM) purposes in order to maximize the potential revenue generated by the entire seat capacity available in that market.

Airlines usually store their inventory on a Computerized Reservation System (CRS). The CRS allows airlines to store and retrieve inventory information and also perform air travel transactions. There are a number of known CRSs provided by third parties which provide inventory hosting services for airlines. Some airlines, however, prefer to have their own dedicated CRS which they use to manage their inventory. Revenue Management (RM) policies for an airline are executed by an Inventory Control mechanism in the CRS. The Inventory Control mechanism is usually an integral part of the CRS.

In the early sixties there was a single price for anyone who wanted to fly on a segment or leg of a journey between a given city pair. Anyone who travelled on that segment paid the same fare. Soon enough, it was recognized that this strategy of a single price point was not optimal. For example, there are customers who are willing to pay different prices for a ticket. To provide for this demand, airlines created different products at different price points. Accordingly differing amounts of seat availability were provided for each price point according to demand for each product type. By introducing additional products, the airlines segmented the market and allocated different amounts of supply for each price level in order to increase the potential revenue.

Airlines typically use a Revenue Management System (RMS) to determine the optimal seat allocations for each product. A Revenue Management System can be thought of as a planning tool which generates strategies or recommendations, such as pricing and inventory control policies. A Computer Reservation System (CRS) is generally used to execute those recommendations.

RMS strategies are usually executed by Inventory Control functionality which is embedded within the CRSs. Although CRSs were originally developed to keep track of the passengers on each flight and to support the sales process, in time it was discovered that they can be used to manage the inventory albeit with some limitations.

Current inventory control systems, also referred to as leg or segment control systems, work by setting booking limits for booking classes. Once a specified number of bookings are accepted to a booking class, then no more bookings are accepted. A seat accounting system indicates under what circumstances classes should be closed for bookings.

One problem with such an inventory control system is that they maintain their inventory by flight leg or segment and by booking class. As such, all the Inventory Control policies created by RMSs must be converted to or generated in terms of leg or segment and booking class.

A further problem which airlines are currently facing is how to segment their market so that they can control each market segment separately.

Passengers travel on an Origin-Destination, which is usually served by collection of legs or segments. Unfortunately there is no mechanism in CRSs that opens or closes Inventory availability for the entire Origin-Destination. Thus, on a given leg-booking class, there are mixed passengers, including local and connecting traffic, with different Origins and Destinations. In other words, one booking class for a particular leg may include different bookings with a variety of attributes. For example, on some legs, especially those feeding long haul flights, there maybe local passengers worth say USD $50 to $100 and connecting passengers worth more than USD $1000 within the same fare class. In other words, non stop passengers are mixed with connecting passengers and they all are subject to the same control parameters. When a fare class is closed for booking, it is closed for all passenger types including non-stop and connecting passengers.

One known solution to this problem which allows the CRS to control connecting traffic is Origin Destination (OD) control. OD RMSs provided significant incremental revenue to those airlines with significant connecting traffic. OD solutions can be classified as (1) Bid Price based solutions and (2) Dynamically Adjusted Virtual Nesting (DAVN) based solutions.

Both solutions require sophisticated network optimization tools to calculate bid price which is sometimes referred to as displacement costs. Bid price based systems make an availability decision by comparing the approximate value of the availability request to the bid price i.e. the minimum acceptable price. The DAVN solution groups the passengers with similar dollar value for each leg and sets separate inventory control limits for each group.

Such OD systems are rather expensive and some of CRSs have not implemented the incremental changes needed to accommodate the needs of an OD RMSs. A further problem with such an OD system is that they also require organizational changes in the Revenue Management (RM) departments and are conceptually hard to explain to Inventory Control analysts. It is a significant project to implement particularly for those small airlines with simple and small RM departments. Some of these airlines do not have significant connecting traffic to justify the investment on an OD RMS and yet they can benefit significantly by controlling the local and connecting traffic separately.

### SUMMARY OF THE INVENTION

Embodiments of the invention seek to address the above problems by segmenting product availability in a flexible manner which better defines the market segment using specific attributes for a particular market segment. This may be achieved without using OD control by defining an attribute which distinguishes local from connecting passengers. This allows each market segment to be separately controlled. Embodiments of the invention may set seat availability open or close indicators in dependence on one or more of the attributes.

Embodiments of the invention provide both OD and leg or segment (allocation) inventory control methodologies. This enables a closely controlled sale of seats. The attributes which define a bucket or segment may uniquely identify local and connecting traffic, thereby allowing definition of different inventory controls limits for local and connecting traffic. The attributes which define a bucket or segment may also uniquely identify single leg journeys and multi-leg journeys, thereby allowing definition of different inventory controls limits for single and multiple leg traffic.

Each leg of a journey may have a bucked defined for it or use a default bucket if no bucket is specifically defined for that particular leg of the journey. Therefore, the attributes which define one bucket for one particular leg of a journey may be different from the attributes which define a different leg of a journey.

According to a first aspect of the present invention, there is provided an inventory control system comprising: a processor, a receiver for receiving an availability request for a leg of a journey between an origin and destination, wherein the availability request comprises one or more attributes defining the leg; a comparator for comparing the attribute or attributes of the received availability request with data defining a plurality of products, each product defined by a plurality of attributes comprising an attribute which allows a local or non-stop passenger to be distinguished from a connecting passenger; wherein the processor is configured to determine the availability of one of the products in dependence upon the result of the comparison.

Alternatively, or in addition to the attribute distinguishing a local or non-stop passenger from a connecting passenger, an attribute may be provided which is indicative of the number of legs of the journey. Preferably, the received availability request is stored in a memory, such as a random access memory, after the availability request is received by the inventory control server.

A further attribute or attributes is usually provided which distinguishes a product or service for a first journey having a first number of legs from a product or service for a second journey having a second number of legs which is less than the first number of legs. The first number of legs is usually at least 2 and the second number of legs is usually at least 1.

Embodiments of the invention may be computer implemented in software code; but they implemented in solid state hardware and the like.

The further attribute may comprise data indicative of the maximum and minimum market value range of the product. A processor may be configured to determine which product has the widest range between maximum and minimum market value range or which product has the highest market value range. Each product may comprise an attribute indicative of the maximum number of seats allocated to each product. The product or service may be a leg of a journey or flight.

Further, the data defining each product may comprise an availability status attribute indicating whether the product is open or closed for providing seats for an availability request. The product or service may be a leg of a journey or flight. One or more of the further attributes may uniquely distinguish a product or service for a local or non-stop passenger from a product or service for a connecting passenger. One or more of the products or services may be reserved only for a connecting or multi-leg journey passenger, and not for a single leg journey.

The further attribute may comprises a reservation booking designator attribute for distinguishing a product or service for a local or non-stop passenger to be distinguished from product or service for a connecting passenger or data allowing a product or service for a single leg journey to be distinguished from a product or service for a multi-leg journey.

The processor may be configured to determine which product has an attribute defining the product as a multi leg product or a connecting passenger product.

The data defining each product may comprise an availability status, AVS, class attribute.

The processor may send to a computer reservation or global distribution system an availability status, AVS, class attribute of a product having an attribute defining the product as a single leg product or a product for local passengers or a product for non-stop passengers.

The processor may be configured to determine the availability of one of the products by matching one or more of the attributes of the availability request to one or more of the attributes defining the products.

The processor may be configured to match one or more of a cabin attribute, a reservation booking designator attribute, a fare attribute, a market value range attribute, and a point of sale attribute.

The processor may be configured to transform one or more attributes of the availability request into a key value such as an integer and in which the processor is configured to search a table of key values associated with product identifiers to determine which product has an associated key value which matches the key value produced by the Hash function.

### BRIEF DESCRIPTION OF THE DRAWINGS

Embodiments of the invention will now be described, by way of example only, and with reference to the accompanying drawings, in which:

FIG. 1 shows a schematic representation of the main functional components embodying the invention;

FIG. 2 is a schematic diagram showing how the relationships between different buckets are defined;

FIG. 3 is a schematic diagram showing how embodiments of the invention may control seat availability of flights between three airports;

FIG. 4 is a schematic diagram showing how a Hash function is used by embodiments of the invention;

FIG. 5 is a schematic diagram showing the interrelation of 5 buckets; and

FIG. 6 is a schematic diagram showing how the availability of a parent bucket may affect the availability of a child bucket.

The following description is of an inventory control system for use in the aviation industry, but this is exemplary and other applications of the invention will also be discussed. For example, the inventory system may be used in the rail industry and coach travel industry. Further, embodiments of the invention may be advantageously used in any system where Revenue Management concepts are used, for example to sell a perishable commodity. Examples include, but are not limited to, inventory control systems for car rentals, cruise lines.

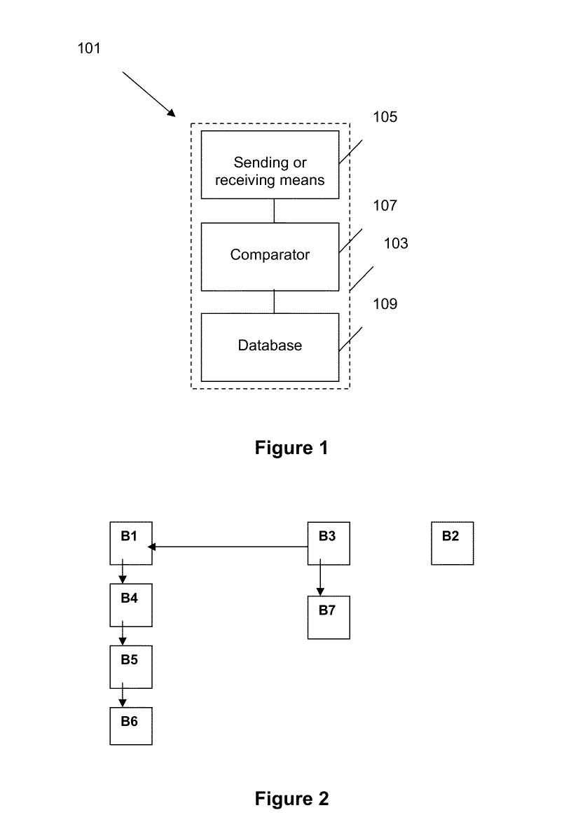

Referring now to FIG. 1, this shows an inventory system 101 according to an embodiment of the invention. The system 101 is referred to as a Horizon Inventory, and operates as will be explained in further detail below.

The system 101 comprises a receiving means 105 for receiving a seat availability request from a travel agent or shopping engine or airline website and the like. The receiving means is communicatively coupled to a comparator 107, the function of which will be described in further detail below. The comparator 107 is also communicatively coupled to an inventory database 109. The database 109 will also be described in further detail below. The database is usually stored in a storage means or device such as a hard disk, flash memory, or rewriteable disc or a solid state memory.

Usually, one or more of the receiving means 105, comparator 107 and the database 109 are provided on a single computer or server 103 embodying the inventory control system 101. In this case, the receiving means may include a Local Area Network (LAN) or wireless network which is communicatively coupled to the travel agent or the like. However, these functional components may be provided on separate computers or servers or alternatively may be provided by hard wired electronic circuitry.

The structure of the database will now be described. As part of the database, one or more buckets are defined. A bucket may be thought of as a logical subdivision of the bookings within a cabin. Each bucket is defined by one or more attributes, and a number of seats within a cabin are associated with each bucket. However, the relationship between a particular seat within the cabin and a bucket is not established until that seat is sold. Multiple buckets can be defined within the same compartment, each bucket having its own set of attributes. A seat may be associated with any one or more of these buckets based upon the attributes associated with the sale.

By establishing a robust set of attributes with which a bucket is defined, embodiments of the invention are able to more precisely differentiate bookings compared with prior art systems. The set of attributes defined by embodiments of the invention may include one or more of the following attributes:
1. Bucket Identifier—a number between 1 and the maximum number of buckets that can be defined.
2. Cabin—a physical cabin where the seats exist.
3. Compartment—a logical division of seats within a physical cabin.
4. Booking Class—a Reservation Booking Designator (RBD) that is used to book seats in a bucket.
5. Market Value Range—an upper and lower range for the market values that can be booked in a bucket. The Market Value is defined as currency range value of the passenger for the airline.
6. Service Indicator—may be used to distinguish between non-stop and connecting services.
7. Point of Sale (POS) Identifier (ID)—an alphanumeric character identifier, up to eight characters in length, specified by the airline identifying a Point of Sale.
8. AVS Class—Availability Status Class (AVS) Class is an indicator of the class of service whose availability is sent to legacy GDS/CRS systems for a bucket. This ensures compatibility with legacy systems. If blank, then the AVS will not be sent for a bucket. It will be noted that the AVS Class is similar to the RBD. However, the AVS Class indicates the availability status, that is to say open or closed status of a RBD. Conventional RBDs usually only have one attribute, a fare class.
Thus, the AVS Class indicates the availability status of a fare class. As shown in table 1, embodiments of the invention change the definition of the RBD by adding more attributes to the RBD. However, modifying the RBD is not straightforward because legacy systems still treat the RBD as just a booking class. Embodiments of the invention may define an additional RBD attribute or attributes. The additional RBD attribute or attributes may allow a local or non-stop passenger to be distinguished from a connecting passenger. Alternatively or in addition, the additional RBD attribute or attributes may allow a single leg journey to be distinguished from a multi-leg journey.
In this way, embodiments of the invention define a new RBD in such a way that the same fare class may appear in multiple RBDs. Thus it is necessary to define which one of these RBDs will be used in order to define the open or close status of a fare class for legacy systems. This is because, airlines preferably continue sending AVS messages to legacy systems, specifically GDSs to communicate the open or close status for their fare classes.
9. Allocation—the number of seats that may be sold in a bucket.
10. Nesting—indicators showing the relationship of one bucket to other buckets.

Each bucket is defined by one or more of the above attributes for each leg of a journey. A journey between an Origin Destination (OD) such as a city pair may comprise a plurality or legs or segments. Each segment may have more than one leg. This can only happen if the connecting legs of a segment have the same flight number. For example if a flight departs from airport AAA to airport BBB and then continues to airport CCC with the same flight number, then in this example, there are three segments: AAA-BBB, BBB-CCC, and AAA-CCC, but only two legs: AAA-BBB and BBB-CCC.

The market value range data is an attribute which may allow local passengers or non-stop passengers to be distinguished from connecting passengers. Alternatively, or in addition to the market value range data, an attribute may be provided which is indicative of the number of legs of the journey.

Alternatively or in addition, each bucket may include a separate attribute, such as a service indicator, which allows local passengers or non-stop passengers to be distinguished from connecting passengers. The service indicator may be used to distinguish between non-stop and connecting services. The service indicator may also comprise an attribute indicative of the number of legs of the journey.

The attributes defining one or more buckets may be grouped together to form a bucket definition table. Multiple bucket definition tables may be defined, but each table has its own unique identifier. Each flight leg usually has a bucket table associated with it. However, if a leg does not have an associated bucket table, then a default bucket table is defined and that bucket table for the leg's equipment type is used.

The bucket's attributes, which are defined in the tables, describe the bucket and its relationship to the booking process. Client airline representatives may define the buckets using an inventory management system user interface. Some characteristics of these buckets are:
Buckets are defined within a physical cabin at the leg or segment level.
Each leg or segment may have multiple buckets defined on it, but only one bucket table.
A booking class is an attribute of a bucket and it may appear in multiple buckets in the table. For example, there are multiple market value ranges within the same booking class. The purpose of this is to separate the local passengers from connecting passengers and to allow the setting of separate controls for each bucket. However, only one of these buckets, preferably the one controlling the local traffic, may be used for AVS purposes.
Each bucket has a seat allocation amount.
Buckets may be interrelated by a nesting structure. This is described below in further detail referring to FIG. 2 of the drawings.

The client airline defines one or more bucket definition tables based upon their revenue management goals. Each table is given a unique identity which may be associated with legs or segments on which the client airline provides a service. The rows of the table define the attributes of subdivisions of their revenue range. The revenue range represents the value of the customers to be inventory controlled as a group differently than those outside that revenue range. The profile defined by the table can be applied to a group of legs which have similar revenue characteristics. In this way, the client can adjust the booking profile of legs to match their optimal revenue scenario and thereby, maximize their revenue opportunity. Table 1 shows a typical bucket definition table for a three cabin aircraft.

TABLE 1
A sample Bucket Definition Table

| | | | | Service | | | | | |
|---|---|---|---|---|---|---|---|---|---|
| Bucket | | Comp/ | | Indicator | Market Value | | | | Authorized |
| ID | Cabin | RBD | RBD | or Type | Range | | POS | AVS | limit |
| 1 | First | RBD | F | | 4000 | 6000 | | F | 24 |
| 2 | First | RBD | R | | 3000 | 6000 | 12345678 | | 24 |
| 3 | First | RBD | A | | 2500 | 4000 | | | 12 |
| 4 | First | RBD | T | | 2000 | 3000 | 87654321 | | 10 |
| 5 | Business | RBD | J | | 2000 | 4000 | | C | 60 |
| 6 | Business | RBD | J | | 1000 | 2000 | | | 50 |
| 7 | Business | RBD | J | | 750 | 3500 | US | | 45 |
| 8 | Business | RBD | U | | 800 | 3900 | UK | | 45 |
| 9 | Business | RBD | W | | 500 | 1500 | | | 20 |
| 10 | Coach | Comp | Y | | 150 | 2000 | | Y | 250 |
| 11 | Coach1 | Comp | S | | 1200 | 2000 | | | 30 |
| 12 | Coach | RBD | B | | 1500 | 2000 | | B | 220 |
| 13 | Coach | RBD | H | | 1250 | 1500 | | H | 170 |
| 14 | Coach | RBD | Q | | 1000 | 1250 | | Q | 140 |
| 15 | Coach | RBD | V | | 900 | 1000 | | V | 110 |
| 16 | Coach | RBD | K | | 750 | 900 | | K | 95 |
| 17a | Coach | RBD | P | L | 600 | 750 | | P | 65 |
| 17b | Coach | RBD | P | C | 600 | 750 | | P | 50 |
| 18 | Coach | RBD | T | | 450 | 600 | | T | 40 |
| 19 | Coach | RBD | G | | 250 | 450 | | G | 30 |
| 20a | Coach | RBD | L | | 100 | 250 | | L | 15 |
| 20b | Coach | RBD | L | L | 100 | 250 | UK | L | 15 |
| 20c | Coach | RBD | L | C | 100 | 250 | US | L | 15 |
| 21 | Coach2 | Comp | X | | 1000 | 1500 | LAX | | 15 |
| 22 | Coach1 | RBD | M | | 1000 | 1500 | US | | 20 |
| 23 | Coach1 | RBD | Z | | 100 | 1000 | 49285401 | | 10 |

In table 1, each of the logical subdivision of the bookings in a row be defined by one or more of the attributes such as cabin, compartment or reservation booking designator (RBD), market value range, Point of Sale, AVS, and authorized limit, as shown at the top of each column of table 1.

The seats allocated to a bucket may first be defined according to which cabin the seat is located. For example, in this 3 cabin aircraft, each seat may be located in a first cabin, or a business cabin or a coach cabin. The coach cabin may be further subdivided into coach 1 cabin and coach 2 cabin.

Each physical cabin may be further logically divided into compartments. For example, in table 1, the coach cabin has 3 compartments Y, S, and X, which determines some of the attributes of seats assigned to buckets 10, 11 and 21.

In the example shown in table 1, the Market Value Range attribute is used as proxy to identify or distinguish the local passengers from the connecting passengers. This is based on the fact that the local passengers pay a different fee to the connecting passengers. The POS attribute, AVS attribute and authorized limit attributes may also be specified, and these are described in further detail below. Alternatively, or in addition, an additional attribute referred to as a service indicator may be defined for each of the buckets. The service indicator allows non-stop flights to be distinguished from connecting flights. In other words, the service indicator allows single leg journeys to be distinguished from multi-leg journeys.

In one embodiment of the invention, the inventory control system may comprise a bucket definition table as shown in table 1 above. In table 1, the available bookings within a cabin are logically subdivided into a number of rows or buckets, with each row labelled with a unique identifier. Each row is defined by one or more attributes, and the authorised limit associated with each row represents the maximum number of bookings which a service provider will allow for a number of booking requests with attributes matching those of a row.

The current number of reservations is a further attribute which may be associated with each subdivision of the bookings. This represents the number of seats which have been sold in a particular bucket or row. This attribute is not shown in table 1, although it will be clear that a booking will only be allowed if the number of seats sold in a particular row is less than the authorised limit attribute of that row or bucket.

One attribute may be provided which allows a local passenger (non-stop passenger) to be distinguished from a connecting passenger. In other words, a single attribute may be provided which allows a single leg journey to be distinguished from a multi-leg journey.

### Service Indicator

In the example definition table shown in table 1, some of the logical subdivisions or rows include a service indicator or service type which uniquely distinguishes between buckets allocated for non-stop (local) and for connecting (through) services. For example, row or bucket number 17a may have a service indicator “L”. The service indicator L in row 17a may indicate that the bookings in row 17a may only be allocated to non-stop or local passengers. Further, row or bucket number 17b may have a service indicator “C”. The service indicator C in row 17b may indicate that the bookings in row 17b may only be allocated to connecting or through passengers. It will be noted that the attributes defining rows 17a and 17b shown in table 1 are identical, other than the service indicator attribute. Thus, the service indicator attribute allows for separate availability to be provided for local passengers in row 17a as well as separate availability to be provided for connecting passengers in row 17b.

This may be achieved by having a bucket or subdivision of the bookings which may only be allocated to a single leg or non-stop or local passenger. A different bucket or subdivision of the bookings may be provided only for multi-leg or connecting or through passenger. As described above, with the exception of the service indicator attribute, the attributes of one subdivision of the bookings for a local passenger may be substantially the same as the attributes of a different subdivision of the bookings for a connecting passenger. Thus, the availability status of one logical subdivision of the bookings for a local passenger can be changed independently of the availability status of a logical subdivision of the bookings for a connecting passenger.

Providing a service indicator such as a single alphanumeric character which uniquely distinguishes between availability for local and connecting passengers allows service providers to use a relatively simple revenue management system rather than using more complicated threshold control logic.

Market Value Range attribute

Alternatively, or in addition to using a service indicator, a service provider may use the market value range attribute to distinguish between the allocated availability for a local passenger and the allocated availability for a connecting passenger. For example, suppose row 5 of table 1 defines a market value range of 2000 to up to, but not including 4000, while row 6 in table 1 defines a market value range from 1000 up to, but not including 2000.

Thus, as a fare for a booking request of a connecting passenger is likely to be considerably higher than the fare for a booking request of a local passenger, the service provider can distinguish between booking requests from these 2 passenger types. The booking requests may be distinguished based on whether the booking request falls within the market value range of 1000 up to, but not including 2000, or within the range of 2000 up to, but not including 4000. Thus, the service provider can close row 6 meaning that there is no availability for a local passenger, but can keep row 5 open, meaning that there is availability for a connecting passenger. Thus, the availability status of one logical subdivision of the bookings for a local passenger can be changed independently of the availability status of a logical subdivision of the bookings for a connecting passenger.

Embodiments of the invention which use the market value range attribute to distinguish local passengers from connecting passengers are particularly suited to providers with comparatively simple inventory systems. This is because all service providers use the market value range attribute, irrespective of the complexity of their system.

In a further embodiment, a plurality of attributes may be provided which allows a local passenger (non-stop passenger) to be distinguished from a connecting passenger.

### RBD Attribute

In a further example, alternatively or in addition to the market value range attribute, a reservation booking designator attribute, RBD, may be provided which allows the logical subdivision of bookings allocated for a local passenger to be distinguished from the logical subdivision of bookings allocated for a connecting passenger.

For example, as shown in table 1, a RBD indicator of “B” shown in row 12 of table 1 may indicate that the logical subdivision of bookings in bucket 12 are for a connecting passenger, while a RBD of “Q” may indicate that the logical subdivision of bookings in bucket 14 are for a local passenger. The RBD indicator of “H” may indicate a bucket which is available for both local and connecting passengers.

Having an RBD indicator which allows a local passenger to be distinguished from a connecting passenger provides a further way for a service provider to distinguish bookings from these 2 passenger types. Thus, finer control of the bookings at the leg level may be achieved.

In a further example, the availability request for a booking received from a user may comprise a service indicator attribute which uniquely distinguishes availability requests of a local passenger from that of a connecting passenger.

Preferably, however, embodiments of the invention may also include additional control logic configured to distinguish an availability request for a booking associated with a local passenger from an availability request for a booking associated with a connecting passenger, without receiving a service indicator attribute as part of the availability request. This avoids the need for the availability request to include a service indicator which uniquely distinguishes availability request of a local passenger from an availability request of a connecting passenger. This may be advantageous because the system may have more compatibility with legacy inventory control systems than might otherwise be the case.

In one example, the availability request received from a user may comprise data indicative that the availability request is associated with a local passenger or a connecting passenger.

The data may comprise data indicative of whether one or more additional legs or segments (which may include one or more legs) have previously been booked or whether the user has been wait-listed for availability within a particular booking class if that booking class is currently closed or full. The availability request may also comprise data indicative of the pricing value of the availability request.

The local vs. through passengers may be divided in to smaller assignments by adding their PoS and different values depending on the value of the different through value and actual through itinerary of the passenger.

One of the advantages embodiments of the invention have over bid price methods is the ability to distinguish values with just the itinerary and PoS, rather than using a market value. Using a market value means that more complicated RMS system may be needed to support the structure.

The received availability request may also comprise data indicative of the origin of the availability request, for example, the travel agent or other ticket sales provider.

Embodiments of the invention receive the availability request including one or more of the multi-leg data, or/and pricing value data, or/and availability request origin data from the received availability request. The system may then determine, preferably based on one or more of the multi-leg data, pricing value data, and availability request origin data, whether the availability request is associated with a single leg or multi-leg journey. The system may alternatively or in addition determine, preferably based on one or more of the multi-leg data, pricing value data, and availability request origin data, whether the availability request is associated with a local or connecting passenger. The system may alternatively or in addition determine, preferably based on one or more of the multi-leg data, pricing value data, and availability request origin data, whether the availability request is associated with a non-stop or through passenger.

Using a plurality of attributes to distinguish a subdivision of the bookings for local passengers from a subdivision of the bookings for connecting passengers allows more precise control of the bookings at the leg level. However, this does require a service provider to implement a more complicated system which can handle indicators which can distinguish local passengers from connecting passengers.

Additional factors may also be used to distinguish booking requests of local passengers from connecting passengers since these factors may affect the market value range data. For example, the point of sale (PoS) attribute may also be used in determining whether the booking request is likely to be that of a local passenger or a connecting passenger.

Thus, as outlined above, a flexible booking or bucket definition table may be provided in which a plurality of attributes are provided which allows local passenger to be distinguished from a connecting passenger. The system is flexible because each service provider may configure their booking system to use one or more of the attributes which allows a local passenger to be distinguished from a connecting passenger. Thus, a single booking definition table structure may be provided with a set number of attributes may be established which can be used by all types of service providers irrespective of the complexity of their booking system.

A bucket or subdivision of the bookings which may only be allocated to a single leg or non-stop or local passenger. A different bucket or subdivision of the bookings may be provided only for multi-leg or connecting or through passenger.

Further, in order to determine whether a particular subdivision of the bookings for a non-stop or a connecting passenger, the Point of Sale (PoS) attribute may be used. For example, suppose that the RBD indicators in buckets 20b and 20c are identical.

The marked value range cannot be used to determine whether bucket 20b or 20c is for a non-stop or a connecting passenger, since these are also identical.

However, the PoS attribute of bucket 20b is different to the PoS attribute of bucket 20c, and this may be used to determine whether bucket 20b or 20c is for a non-stop passenger based on the PoS attribute of a bucket. Thus, because of the different pricing structure of UK and US PoS for buckets 20b and 20c a determination can be made of whether a bucket is for a non-stop or connecting passenger based on the PoS attribute. In the example shown in table 1, a determination may be made that bucket 20c is for a connecting passenger and bucket 20b is for a local passenger.

Although embodiments of the invention have been described referring to distinguishing a product or service for a single leg journey and a product or service for a multi-leg journey, embodiments of the invention may provide separate products for a journey having any number of legs. Thus, a first subdivision of the bookings for a 2-leg journey may be provided and a second subdivision of the bookings may be provided for a 3-leg journey. Thus, the availability status attribute associated with the first subdivision of the bookings may be closed while keeping the availability status attribute associated with the second subdivision of the bookings open.

If Buckets B1 to B23 shown in table 1 are not nested, then the sum of the number of number of seats allocated to buckets B1 to B23 is equal to the total number of seats available on the flight. However, as will be described in further detail below, some of these buckets may be nested. In this case, the number of seats allocated to one bucket are also available to other nested bucket(s).

It should be noted that this table is intended as an example only. It does not cover the full scenarios that airlines may experience. Embodiments of the invention define a sufficient number of different buckets so that there is always a bucket defined for availability requests received. This may require airlines to define a catch all type of bucket definition in case there is no bucket defined for a certain scenario. This table may be applied to any legs whose equipment type, for example the particular type of aircraft being used, which matches the allocations presented in the table.

An airline can define a number of these bucket definition tables. Again, based on the Revenue Management practices of the airline, one of these tables is linked to a flight departure leg or segment. In order to simplify the business process and eliminate the need to identify a bucket definition table with every flight leg in the schedule, a default bucket structure may be defined for the entire system, or by equipment type, and so on.

This bucket structure can be combined with an accounting system. The accounting system, may define the relationship between each bucket as parent-child or siblings.

Based on these relationships, the accounting system can calculate the seat availability for any bucket.

FIG. 2 shows the relationship between different buckets B1, B2, B3, B4, B5, B6, and B7. Bucket B2 has no child buckets or parent buckets. However, bucket B3 has 2 child buckets, buckets B7 and B1. Similarly, bucket B7 has one parent bucket, bucket B3. Bucket B1 also has a child bucket B4 while bucket B4 has a child bucket B5. Bucket B5 also has a child bucket B6 which has no child buckets.

The buckets may be interrelated by a nesting structure that may employ either net or theft accounting. Net accounting is restricted to upward seat adjustments, whereas theft accounting causes seat adjustments both up and down within the nesting structure. Each of these buckets is available within a physical cabin.

The nesting structure of the buckets shown in FIG. 2 may apply to the bucket definition table shown in table 1, although this does not necessarily need to be the case, and a different nesting structure may be applied to the bucket definition table shown in table 1.

The bucket definitions for buckets B2 and B3 may overlap. This means that the sum of the number of seats allocated to buckets B2 and B3 is not necessarily equal to the total number of seats available on a flight. This is acceptable provided buckets B2 and B3 are not nested or there is no nesting relationship between them. Buckets B2 and B3 are schematically shown in FIG. 2 as not being nested because there is no arrow linking the 2 buckets.

As a result, sometimes a single booking can be tallied in multiple buckets. As long as those buckets are independent it is acceptable. However, embodiments of the invention do not allow nested buckets to have overlapping scope definition. This is because a single booking request will impact the total availability in the flight due to double counting.

However, bucket B3 has also access to the inventory or seat availability that is allocated to buckets B1 and B7. Further, bucket B1 also has access to it's sub-buckets B4, B5, B6.

Even though each bucket is defined by a bucket definition table, the relationship between buckets as described in this picture determines the availability calculation for any given bucket. The relationship between buckets is defined in the nesting structure. The bucket nesting structure is separately defined for each leg or segment.

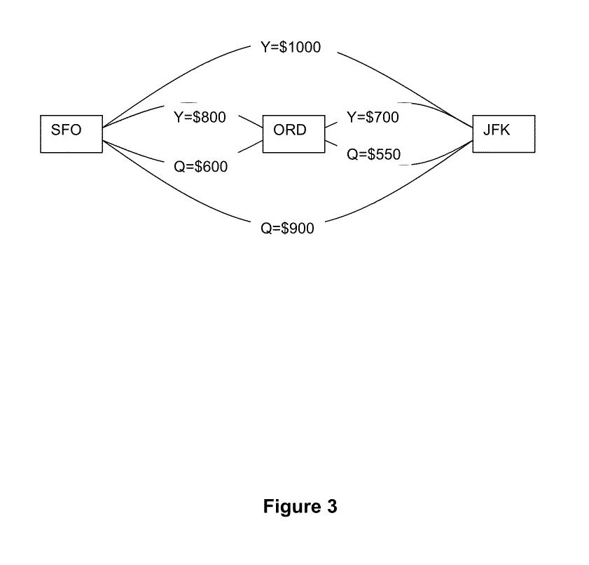

Referring now to FIG. 3, this is a schematic diagram showing how embodiments of the invention control seat availability between three airports, San Francisco (SFO), Chicago O'Hare (ORD), and New York (JFK).

In this example, it is assumed that there is only one non-stop flight between San Francisco (SFO) and Chicago O'Hare (ORD) and only one non-stop flight between ORD and New York (JFK) with connection opportunities at Chicago O'Hare. In this small network, there are passengers travelling from SFO to ORD, or SFO to JFK connecting over ORD and from ORD to JFK. As such, on the non-stop legs between SFO-ORD or ORD-JFK, there are connecting passengers in addition to the local passengers travelling on those legs. In reality airlines define many different fares on each Origin and Destination (OD). However, in order to simplify the problem let us assume there are two types of passengers which may be characterised by a fare class: Y (Business) and a fare class Q (leisure) on each OD. Presumably, on each leg of a flight, there may be passengers with different ODs e.g. SFO to ORD or ORD to JFK or SFO to JFK (connecting).

Referring now to table 2, this is an example of a bucket table which may be used by embodiments of the invention to control seat availability on flights between the three airports shown in FIG. 2. With the exception of the availability status attribute, the attributes of each bucket shown in table 2 correspond to those shown in table 1, and so will not be described again in detail.

The availability status attribute, which may be set either to Closed or Open, indicates whether a particular bucket is open or closed, that is to say whether a particular bucket can be used to provide seats for a particular availability request.

TABLE 2
A bucket definition table according to embodiments of the invention

| | | | | Market Value | | | | Availability |
|---|---|---|---|---|---|---|---|---|
| Bucket ID | Cabin | Comp/RBD | RBD | Range ($) | | POS | AVS | Status |
| 1 | Coach | RBD | Y | 0 | 900 | | Y | Closed |
| 2 | Coach | RBD | Y | 901 | 99999 | | | open |
| 3 | Coach | RBD | Q | 0 | 700 | | Q | Closed |
| 4 | Coach | RBD | Q | 701 | 99999 | | | Open |

By using such a structure, embodiments of the invention can close a fare class on a leg, for local passengers say, Y class on the SFO-ORD leg without closing the availability for both SFO-ORD and SFO-JFK passengers. This structure, also referred to as a flexible bucket definition, introduces finer level control at the leg level to recognize the real value of the demand and sets the open close indicators accordingly.

In other words, embodiments of the invention are able to control the availability of a leg of a journey for local passengers independently from the availability for connecting passengers. This may be achieved by including an indicator which distinguishes local from connecting passengers. In this example, the Market Value Range is used as proxy to identify the local passengers from the connecting passengers. This is based on the assumption that the local passengers will be paying a different fee to the connecting passengers. Alternatively, or in addition, an additional attribute referred to as a service indicator may be defined for each of the buckets. The service indicator allows non-stop or local flights to be distinguished from connecting flights. In other words, the service indicator allows single leg journeys to be distinguished from multi-leg journeys.

This is in contrast to prior art systems which work at leg level by opening and closing the availability on each leg, irrespective of whether the availability request is in relation to a local or connecting passenger.

This is particularly advantageous since SFO-ORD and SFO-JFK passengers have different fare levels such as $800 and $1000 respectively. Even if the RMS indicates the optimal policy at a time is to close the SFO-ORD leg Q class and keep Y class open for the same leg, embodiments of the invention allow the SFO-JFK passengers to be accepted since they are connecting passengers. In this way, the bucket structure allows embodiments of the invention to control local and connecting fare classes on the SFO-ORD leg separately.

If an availability request is received for the SFO-ORD leg, then the Inventory Control system determines the fare values for both Y and Q fares. Then it determines which bucket ID will be used to determine the availability for that fare class on that leg. Referring to FIG. 3, and table 2 above, since the local fares are $800 for Y fare class and $600 for Q fare class then the availability for Y and Q fares respectively will be determined by the status of bucket 1 and bucket 3. In this particular example, Local traffic is closed to both Y and Q fares whereas the connecting traffic is open for both Y and Q traffic. This is something that is impossible to do at leg class level of prior art inventory control systems.

### Steps Performed by Embodiments of the Invention:

The various steps performed by embodiments of the invention will now be described, referring to FIGS. 1 to 6 of the drawings.

A travel agency, not shown in FIG. 1, first sends a seat availability request to a server 103. The server 103 receives the request via a receiver 105. Usually the receiver 105 will be a network interface card coupled to the server and Ethernet, such as a Local Area Network (LAN) or Wide Area Network (WAN), but wireless receivers may also be used. The server 103 then determines the attributes of the availability request.

The server 103 then determines which bucket defined in the bucket definition table has attributes matching the availability request. The seats available for that bucket determine the type of response which is sent from the server 103 to the travel agency when the availability request is received by the server 103.

The server 103 matches the attributes of the availability request to one or more buckets in the following way:

Firstly, the server 103 determines the number of legs which connect the origin to the destination. In the example described with reference to FIG. 3, there are 2 legs that connect San Francisco (SFO) to New York (JFK) via Chicago O'Hare.

Secondly, the server 103 determines the requestor. The requestor is the country where the request originates. The requestor may be determined using the POS attribute, of the availability request.

Thirdly, the server 103 lists the fares available, (such as fare class F, B, C, H, Y, Q, V, K, P, S, T, G, L, Z). However, it is not necessary for embodiments of the invention to use any of the above fare classes. In this case, a fare available may be defined using a new product definition. Furthermore, it should be noted that embodiments of the invention do not require all of the previously mentioned attributes to be defined. For example, an airline employing a system embodying the invention may decide to define a bucket that does not have any fare class attribute. Each fare has a financial value associated with it. This is the value that is compared to the market value (low) and market value (high) to determine the bucket number.

Fourthly, the server 103 finds the bucket i.e. row in the bucket definition table which matches the availability request criteria. For example, referring to table 2, and FIG. 3, if the availability request has attributes which define it as an availability request for the SFO-ORD leg with a local fare of $800 for a Y fare class, then, the server 103 compares the attributes of the received availability request to the attributes of the buckets defined in the bucket definition table shown in table 2. In table 2, the fare of $800 falls within the market value range of $0 to $900 of bucket number 1. Also, the RBD of the received availability request matches the RBD of bucket 1. The server 103 then checks the availability status of bucket 1. In this example, the availability status of bucket number 1 is closed, and therefore the server 103 returns a response to the requestor, such as a travel agent, that there this bucket is closed. This means that there is no availability to meet the availability request.

Further, if, for example, the server 103 receives an availability request for the SFO-ORD leg (which connects at ORD onto JFK) with a Y fare class of $1000, then the server compares the attributes of the received availability request to the attributes of the buckets defined in the bucket definition table shown in table 2. In table 2, the fare of $1000 falls within the market value range of $901 to $99999 of bucket number 2. Also, the RBD (which is Y) of the received availability request matches the RBD of bucket 2. The server 103 then checks the availability status of bucket 1. In this example, the availability status of bucket number 2 is open. The server 103 checks that there is sufficient seat availability, shown as the authorized limit column of table 1, and the server 103 returns to the requestor, such as a travel agent, that there is sufficient availability to meet the availability request.

Embodiments of the invention may use a number of different methods to find which bucket matches the availability request criteria. Two methods will be described below, and these are referred to as method 1 and method 2. These methods will be described referring to the sample bucket definition table shown in table 3.

TABLE 3
A sample bucket definition table.

| | | | | Market | Market | | |
|---|---|---|---|---|---|---|---|
| Row | | Comp/ | | Value | Value | | Bucket |
| number | Cabin | RBD | RBD | (low) | (high) | POS | ID |
| . . . | . . . | . . . | . . . | . . . | . . . | . . . | . . . |
| 42 | Coach | RBD | Q | 1000 | | | 14 |
| 43 | Coach | RBD | Q | 800 | 1000 | US | 17 |
| 44 | Coach | RBD | Q | 800 | 1000 | | 19 |
| 45 | Coach | RBD | Q | | 800 | | 21 |
| 46 | Coach | RBD | T | 450 | | | 32 |
| 47 | Coach | RBD | T | | 450 | | 14 |
| 48 | Coach | RBD | S | | | US | 19 |
| 49 | Coach | RBD | S | | | | 36 |
| . . . | . . . | . . . | . . . | . . . | . . . | . . . | . . . |

### 4.1 Method 1

In this method, the server 103 find the row in table 1 with attributes which match the received availability request.

It is a pre-condition that the table is valid. That is to say, when a user builds the table, the user entries must be validated. For example, the user should not define overlapping definitions, should not use invalid fare classes, and should only use available bucket IDs and so on.

The rows in the bucket definition table may be ordered in the order of preference that the bucket should be selected. For example if both rows 42 and 43 in table 3 have attributes which match the received availability request, then row 42, or in other words, bucket 42 is selected in preference to bucket 43.

The server 103 first matches the cabin of the received availability request to buckets or rows with a cabin which matches that in the received availability request. Then the RBD of the availability request is matched to those rows or buckets in the bucket definition table with a matching RBD. In this example, the received availability request has the attributes of coach cabin, and a Comp (Compartment)/RBD of RBD, and a RBD of Q, or in other words, an economy fare.

As shown in Table 3, Line 42 is the first that matches. The server 103 then matches the Market Value Range to that in the received availability request. If the received availability request has a Q fare of $900 value, it can be seen from table 4 below that line 43 is now the first that matches the value, and this is highlighted in bold in table 4.

TABLE 4
A sample bucket definition table.

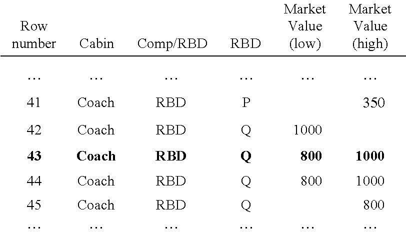

The server 103 then matches the point of sale (POS) of the received availability request to one of the rows of the table. If the point of sale attribute in the received availability request was a point of sale other than “US”, then embodiments of the invention return bucket ID 19, on row 44. This is shown in table 5 below, with the matching row 203 highlighted in bold.

TABLE 5
A sample bucket definition table.

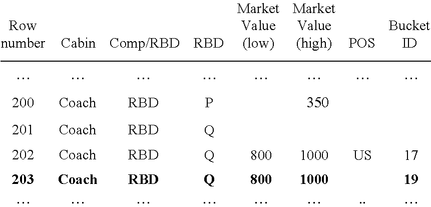

Both tables 4 and 5 allow the server 103 to determine a matching bucket identifier. The main difference between the two tables is that table 5 includes POS definition as a part of the attributes. When a POS is a part of the bucket attributes, it is possible that a request can be matched to more than one bucket. This is because the POS definition can overlap. For example, a European POS and German POS overlap. Any request originating from Germany is also a request originating from European POS. Thus bucket IDs in the 200 range in table 5 cannot be nested. They are independent buckets that impact final availability decisions.

In summary, the server 103 first matches the cabin, then the RBD, then fare, then market value range, then the POS. However, embodiments of the invention may perform these steps in a different order to those specified above. The server 103 then determines determined which bucket matches these criteria and the minimum availability out of all the matching buckets is returned as the availability for the request.

### 4.2 Method 2

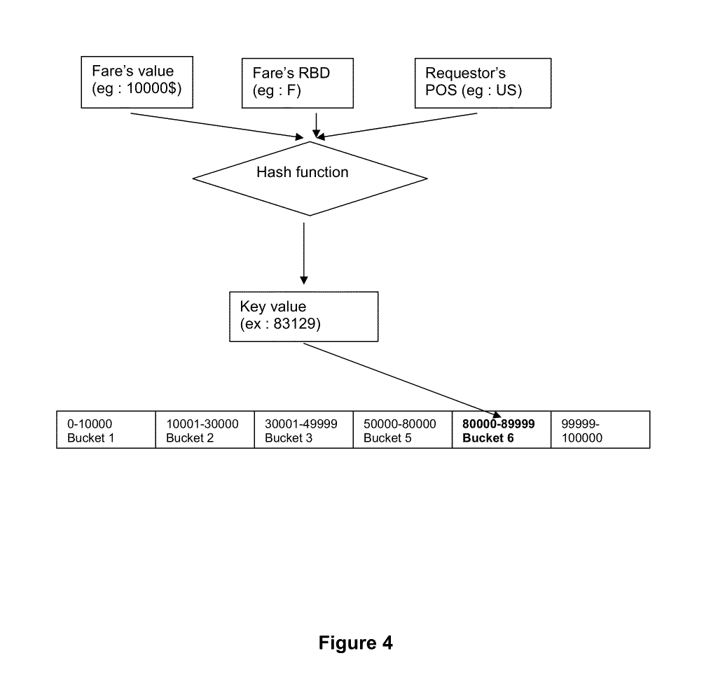

In an alternative embodiment, instead of using method 1 above to determine which bucket matches the availability request, a Hash function may be used to determine which bucket has attributes which match those of the availability request. This is schematically shown in FIG. 4 of the drawings. The Hash function transforms one or more parameters such as fare value e.g. $10000, and fare RBD e.g. F and requestor POS e.g. US into a key value, such as 83129. The key value is usually a single integer.

Once the key value has been determined, a table of key values associated with bucket identifiers is searched to determine which bucket has an associated key value matching the key value produced by the Hash function. Using a Hash function has the advantage that it is more efficient as the number of criteria or attributes increases.

Once the bucket identifier has been determined using method 1 or 2 above, then the bucket identifier is used to determine whether there is availability for each leg defined by the matching bucket identifier by looking at the availability for a particular bucket.

The above steps are then repeated for each leg and for each fare. Therefore, for an availability request for a particular journey, the above steps are repeated n times, where n is the product of the number of legs of the journey multiplied by the number of different fares for each journey.

In some cases, embodiments of the invention return a number or array of availability responses which match an availability request for a particular journey. Each bucket may be indexed by identifier for faster recovery. Each bucket may contain the following data:
the control values limiting the sells for a particular bucket;
the number of seats already sold for this bucket;
the resulting availability for this bucket;
the children buckets, if any; and
the parent bucket, if any.

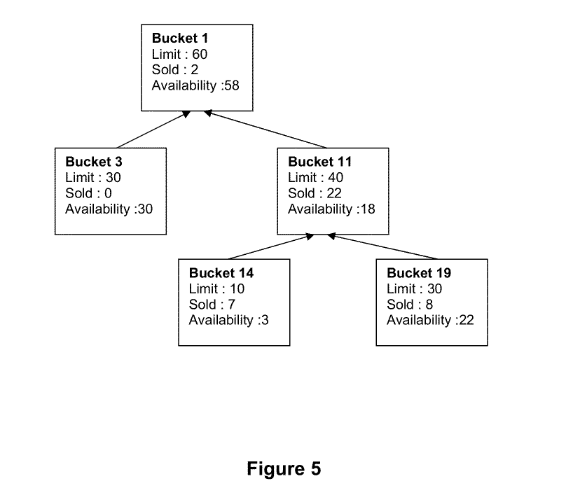

The relationships between buckets is schematically shown in FIG. 5 of the drawings. In this example, bucket 1 is parent of bucket 3 and bucket 11. Bucket 14 and bucket 15 are children of bucket 11.

Any one or more of the buckets shown in FIG. 5 may be returned depending upon the attributes of the availability request.

Then, for each leg, once the bucket identifier has been determined using the methods previously described, the availability of that bucket is capped by its parent's availability. For example, if one bucket is a child of another bucket, then depending on the seat accounting system, any seats that are allocated to the child bucket can also be sold by the parent bucket. This is because usually the parent bucket indicates higher value to the airline.

Referring now to FIG. 5, this further exemplifies the nesting structure of the buckets. In FIG. 5, some of the detailed attributes such as seat sold count, booking limits, and so on have been included.

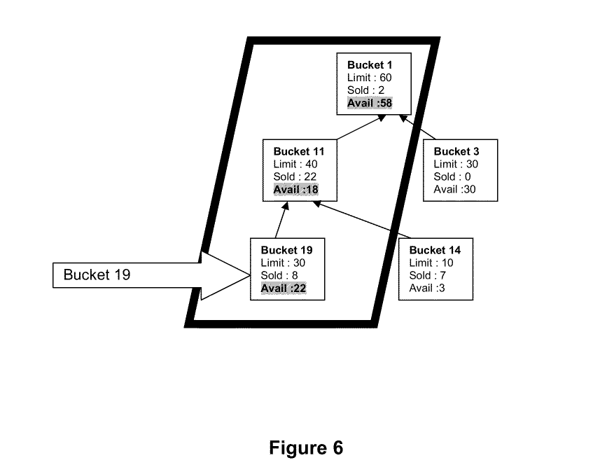

FIG. 6 schematically shows how parent buckets cap the availability of child buckets. In the example shown in FIG. 6, bucket 19 would normally give us an availability of 22. But its parent has an availability of 18, so that will be the final result for bucket 19, the grand-parent Bucket 1 having 58 seats available. The availability of the qualified bucket for a leg is returned as the availability of that leg.

As shown in FIG. 6, bucket 19 with availability of 22 is capped by bucket 11 with an availability of 18. This is because in this case there is more demand for bucket 11 than forecasted and allocated to that bucket, and so bucket 11 can sell more than the allocated number of seats. When this happens it will take seats away from their children buckets if there are still seats available in them.

At the end of this step, the availability of each fare class, for each leg has been determined. Embodiments of the invention then use the determined availability of each fare classes to return the final availability of this connection for each fare class to the travel agency making the availability request. This is sent by the system 101 to the travel agency.

After receiving the returned availability for a particular origin destination, the travel agency may then decide to proceed with booking the seats. The travel agency sends a sell request to server 103. Once the server 103 confirms that there is a sale, the number of seats sold is subtracted from the allocation associated with that bucket.

In other words, the seats sold in the RBD being requested is subtracted from its allocation in the appropriate table for each leg. The sell is permitted if the number of seats available on each leg meets or exceeds the party size. If the sell is permitted, seat accounting is performed on the seats sold counts based upon the nesting structure defined in the table. The combination of the RBD and its seats available is returned as the RBD's availability. This is repeated for all applicable RBDs.

Various modifications to the embodiments described are possible and will occur to those skilled in the art without departing from the invention which is defined by the following claims.

1. An inventory control system comprising:
a. a receiver for receiving an availability request for a desired product or service associated with a leg of a journey between an origin and destination, the availability request comprising one or more attributes defining the desired product or service;
b. a storage device for storing data defining a plurality of products or services of a provider, each product or service defined by one or more attributes; and
a processor configured to compare the attribute or attributes of the received availability request with the stored data, wherein the stored data defining at least one of the products or services comprises one or more further attributes which distinguish a product or service for a first journey having a first number of legs from a product or service for a second journey having a second number of legs which is less than the first number of legs.

2. An inventory control system according to claim 1 wherein the first journey is a multi-leg journey and the second journey is a single leg journey.

3. An inventory control system according to claim 1 wherein the attribute or attributes of the products or services stored in the storage device comprise an availability status indicator attribute for indicating the open or closed status of each product or service stored in the storage device.

4. An inventory control system according to claim 1 wherein the attribute or attributes of the products or services stored in the storage device comprise an availability status indicator attribute for indicating the open or closed status of each product or service stored in the storage device and in which the processor is configured to change the availability status of one product or service for the first journey independently of the availability status of a product or service for the second journey.

5. An inventory control system according to claim 1 wherein the processor is configured to determine whether the availability request is associated with a first journey having a first number of legs or a second journey having a second number of legs which is less than the first number of legs preferably based on one or more of data indicative of whether one or more legs or segments have previously been booked, and data indicative of the origin of the availability request, and data indicative of the pricing value of the availability request.

6. An inventory control system according to claim 1 wherein the processor is configured to determine whether the availability request is associated with a single leg journey or a multi-leg journey preferably based on one or more of data indicative of whether one or more legs or segments have previously been booked, and data indicative of the origin of the availability request, and data indicative of the pricing value of the availability request.

7. An inventory control system according to claim 6 wherein the processor is configured to allocate to a user one of the products or services having the further attribute which identifies the product or service as being for a multi-leg journey if the received availability request comprises data indicative that the journey is a multi-leg journey.

8. An inventory control system according to claim 1 wherein the processor is configured to compare the attributes or attributes of the received availability request with the further attribute which distinguishes a product or service for a local passenger or non-stop passenger or single leg journey from a product or service for a connecting passenger or though passenger or multi leg journey. Define number of legs in received availability request.

9. An inventory control system according to claim 1 wherein the further attribute comprises data indicative of the number of legs of the journey associated with the received availability request.

10. An inventory control system according to claim 1 in which the further attribute comprises a service indicator attribute which allows a product or service for the first journey to be distinguished from a product or service for the second journey, and preferably in which the further attribute comprises one or more of a Point of Sale attribute and pricing value data attribute.

11. An inventory control system according to claim 1 wherein the processor is configured to use one or more of a service indicator attribute and a pricing value data attribute and a Point of Sale attribute to determine whether the product is for the first or second journey.

12. An inventory control system according to claim 1 in which the further attribute comprises a service indicator attribute which allows a product or service for a non-stop passenger or local passenger or single-leg journey to be distinguished from a product or service for a through passenger or connecting passenger or multi leg journey.

13. An inventory control system according to claim 1 in which the processor is configured to determine the availability of one of the products by using a Hash function to determine which product has attributes which match those of the received availability request.

14. An inventory control system according to claim 1 in which the processor is configured to transform one or more attributes of the availability request into a key value such as an integer.

15. An inventory control method comprising:
a. receiving with a receiver an availability request for a desired product or service associated with a leg of a journey between an origin and destination, the availability request comprising one or more attributes defining the desired product or service;
b. comparing, using a processor, the attribute or attributes of the received availability request with data stored in a storage device, the data defining a plurality of products or services of a provider, each product or service defined by one or more attributes; wherein the stored data defining at least one of the products or services comprises one or more further attributes which distinguish a product or service for a first journey having a first number of legs from a product or service for a second journey having a second number of legs which is less than the first number of legs.

16. An inventory control method according to claim 15 in which the first journey is a multi-leg journey and the second journey is a single leg journey.

17. An inventory control method according to claim 15 wherein the attribute or attributes of the products or services stored in the storage device comprise an availability status indicator attribute for indicating the open or closed status of each product or service stored in the storage device.

18. An inventory control method according to claim 15 wherein the attribute or attributes of the products or services stored in the storage device comprise an availability status indicator attribute for indicating the open or closed status of each product or service stored in the storage device and in which the processor is configured to change the availability status of one product or service for the first journey independently of the availability status of a product or service for the second journey.

19. An inventory control method according to claim 15 wherein the processor is configured to determine whether the availability request is associated with a first journey having a first number of legs or a second journey having a second number of legs which is less than the first number of legs preferably based on one or more of data indicative of whether one or more legs or segments have previously been booked, and data indicative of the origin of the availability request, and data indicative of the pricing value of the availability request.

20. An inventory control method according to claim 15 wherein the processor is configured to determine whether the availability request is associated with a single leg journey or a multi-leg journey preferably based on one or more of data indicative of whether one or more legs or segments have previously been booked, and data indicative of the origin of the availability request, and data indicative of the pricing value of the availability request.

21. An inventory control method according to claim 15 wherein the processor is configured to allocate to a user one of the products or services having the further attribute which identifies the product or service as being for a multi-leg journey if the received availability request comprises data indicative that the journey is a multi-leg journey.

22. An inventory control method according to claim 15 wherein the processor is configured to compare the attributes or attributes of the received availability request with the further attribute which distinguishes a product or service for a local passenger or non-stop passenger or single leg journey from a product or service for a connecting passenger or though passenger or multi leg journey.

23. An inventory control method according to claim 15 wherein the further attribute comprises data indicative of the number of legs of the journey associated with the received availability request.

24. An inventory control method according to claim 15 in which the further attribute comprises a service indicator attribute which allows a product or service for the first journey to be distinguished from a product or service for the second journey, and preferably in which the further attribute comprises one or more of a Point of Sale attribute and pricing value data attribute.

25. An inventory control method according to claim 15 wherein the processor is configured to use one or more of a service indicator attribute and a pricing value data attribute and a Point of Sale attribute to determine whether the product is for the first or second journey.

26. An inventory control method according to claim 15 in which the further attribute comprises a service indicator attribute which allows a product or service for a non-stop passenger or local passenger or single-leg journey to be distinguished from a product or service for a through passenger or connecting passenger or multi leg journey.

27. An inventory control method according to claim 15, in which the processor is further configured to determine the availability of one of the products in dependence upon the result of the comparison.

28. An inventory control method according to claim 15 in which the processor compares the attributes or attributes of the received availability request with the further attribute which allows a local or non-stop passenger to be distinguished from a connecting passenger.

29. An inventory control method according to claim 15 wherein the further attribute comprises data indicative of the number of legs of a journey for each product.

30. An inventory control method according to claim 15 in which the processor determines which product has an attribute defining the product as a multi leg product or a product for connecting passengers.

31. An inventory control method according to claim 15 in which each product comprises an attribute indicative of the maximum number of seats allocated to each product.

32. An inventory control method according to claim 15 in which the further attribute comprises a service indicator attribute which allows non-stop or local flights to be distinguished from connecting flights or single leg journeys to be distinguished from multi-leg journeys.

33. An inventory control method according to claim 15 in which the data defining each product comprises an availability status attribute indicating whether the product is open or closed for providing seats for an availability request.

34. An inventory control method according to claim 15 in which the processor determines the availability of one of the products by matching one or more of the attributes of the availability request to one or more of the attributes defining the products.

35. An inventory control method according to claim 15 in which the processor determines the availability of one of the products by using a Hash function to determine which product has attributes which match those of the received availability request.

36. An inventory control method according to claim 15 in which the processor transforms one or more attributes of the availability request into a key value such as an integer.

37. An inventory control method according to claim 15 in which the processor transforms one or more attributes of the availability request into a key value such as an integer and in which the processor searches a table of key values associated with product identifiers to determine which product has an associated key value which matches the key value produced by the Hash function.

38. A computer readable medium which when executed undertakes the method of claim 15.

39. A computer program product comprising the computer readable medium of claim 38.

40. An inventory control system comprising: a processor, a receiver for receiving an availability request for a leg of a journey between an origin and destination, wherein the availability request comprises one or more attributes defining the leg; and a comparator for comparing the attribute or attributes of the received availability request with data defining a plurality of products, each product defined by one or more attributes comprising a further attribute which allows a local or non-stop passenger to be distinguished from a connecting passenger; wherein the processor is configured to determine the availability of one of the products in dependence upon the result of the comparison.

41. An inventory control method comprising receiving on a receiver an availability request for a leg of a journey between an origin and destination, wherein the availability request comprises one or more attributes defining the leg; comparing using a comparator the attribute or attributes of the received availability request with data defining a plurality of products, each product defined by a one or more attributes comprising an attribute which allows a local or non-stop passenger to be distinguished from a connecting passenger; and determining using a processor the availability of one of the products in dependence upon the result of the comparison.
